(19) United States
(12) Patent Application Publication
(10) Pub. No.: US 2014/0236927 A1
(43) Pub. Date: Aug. 21, 2014

(54) INTERNET PRESENCE SCORING

(71) Applicant: i-skore, Inc., Henderso, NV (US)

(72) Inventor: James B. Catledge, Henderson, NV (US)

(73) Assignee: i-skore, Inc., Henderso, NV (US)

(21) Appl. No.: 14/256,165

(22) Filed: Apr. 18, 2014

Related U.S. Application Data
(63) Continuation-in-part of application No. 13/772,986, filed on Feb. 21, 2013.

(51) Int. Cl. G06F 17/30

(52) U.S. Cl. CPC G06F 17/30522
USPC 707/722

(57) ABSTRACT

For scoring Internet presence, a scoring module calculates one or more metrics as a function of sentiment values for results for a search target of a search type that is one of a person search type and a brand search type. The scoring module further calculates an Internet score from the one or more metrics and displays the Internet score.

### CROSS-REFERENCE TO RELATED APPLICATIONS

This is a continuation-in-part application and claims priority to U.S. patent application Ser. No. 13/772,986 entitled “INTERNET PRESENCE SCORING” and filed on Feb. 21, 2013 for James B. Catledge, which is incorporated herein by reference.

### FIELD

The subject matter disclosed herein relates to scoring and more particularly relates to Internet presence scoring.

### BACKGROUND

### Description of the Related Art

Online sources such as Internet web pages, social media, web accessible databases, reviews, and the like are increasingly important in defining public opinion. Evaluating an Internet presence is important for managing advertising, political campaigns, and the like.

### BRIEF SUMMARY

A method for Internet presence scoring is disclosed. A scoring module calculates one or more metrics as a function of sentiment values for results for a search target of a search type that is one of a person search type and a brand search type. The scoring module further calculates an Internet score from the one or more metrics and displays the Internet score.

### BRIEF DESCRIPTION OF THE DRAWINGS

In order that the advantages of the embodiments of the invention will be readily understood, a more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating one embodiment of an Internet presence scoring system;

FIG. 2A is a schematic block diagram illustrating one embodiment of a search database;

FIG. 2B is a schematic block diagram illustrating one embodiment of a search entry;

FIG. 2C is a schematic block diagram illustrating one embodiment of metric data;

FIG. 2D is a schematic block diagram illustrating one embodiment of source data;

FIG. 2E is a schematic block diagram illustrating one embodiment of a result;

FIG. 3A is a schematic block diagram illustrating one embodiment of a computer;

FIG. 3B is a schematic block diagram illustrating one embodiment of a scoring apparatus;

FIG. 4A is an illustration of one embodiment of displayed results;

FIG. 4B is an illustration of one embodiment of sentiment identification;

FIG. 4C is an illustration of one embodiment of sentiment scoring;

FIG. 4D is an illustration of one embodiment of position and sentiment scoring;

FIG. 5A is a schematic flow chart diagram illustrating one embodiment of an Internet presence scoring method;

FIG. 5B is a schematic flow chart diagram illustrating one embodiment of a metric exclusion method;

FIG. 5C is a schematic flow chart diagram illustrating one embodiment of a source exclusion method;

FIG. 5D is a schematic flow chart diagram illustrating one embodiment of a result exclusion method; and

FIGS. 6A-C are illustrations of embodiments of displayed Internet presence scores.

### DETAILED DESCRIPTION OF THE INVENTION

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Furthermore, the described features, advantages, and characteristics of the embodiments may be combined in any suitable manner. One skilled in the relevant art will recognize that the embodiments may be practiced without one or more of the specific features or advantages of a particular embodiment. In other instances, additional features and advantages may be recognized in certain embodiments that may not be present in all embodiments.

These features and advantages of the embodiments will become more fully apparent from the following description and appended claims, or may be learned by the practice of embodiments as set forth hereinafter. As will be appreciated by one skilled in the art, aspects of the present invention may be embodied as a system, method, and/or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module,” or “system.”Furthermore, aspects of the present invention may take the form of a computer program product embodied in one or more non-transitory computer readable medium(s) having program code embodied thereon.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of program code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of program code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network. Where a module or portions of a module are implemented in software, the program code may be stored and/or propagated on in one or more computer readable medium(s).

The computer readable medium may be a tangible, non-transitory computer readable storage medium storing the program code. The computer readable storage medium may be, for example, but not limited to, an electronic, magnetic, optical, electromagnetic, infrared, holographic, micromechanical, or semiconductor system, apparatus, or device, or any suitable combination of the foregoing.

More specific examples of the computer readable storage medium may include but are not limited to a portable computer diskette, a hard disk, a random access memory (RAM), a read-only memory (ROM), an erasable programmable read-only memory (EPROM or Flash memory), a portable compact disc read-only memory (CD-ROM), a digital versatile disc (DVD), an optical storage device, a magnetic storage device, a holographic storage medium, a micromechanical storage device, or any suitable combination of the foregoing. In the context of this document, a computer readable storage medium may be any tangible medium that can contain, and/or store program code for use by and/or in connection with an instruction execution system, apparatus, or device.

Program code for carrying out operations for aspects of the present invention may be written in any combination of one or more programming languages, including an object oriented programming language such as Ruby, Python, Java, Smalltalk, C++, PHP or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The computer program product may be shared, simultaneously serving multiple customers in a flexible, automated fashion. The computer program product may be standardized, requiring little customization and scalable, providing capacity on demand in a pay-as-you-go model.

The computer program product may be stored on a shared file system accessible from one or more servers. The computer program product may be executed via transactions that contain data and server processing requests that use Central Processor Unit (CPU) units on the accessed server. CPU units may be units of time such as minutes, seconds, hours on the central processor of the server. Additionally the accessed server may make requests of other servers that require CPU units. CPU units are an example that represents but one measurement of use. Other measurements of use include but are not limited to network bandwidth, memory usage, storage usage, packet transfers, complete transactions etc.

When multiple customers use the same computer program product via shared execution, transactions are differentiated by the parameters included in the transactions that identify the unique customer and the type of service for that customer. All of the CPU units and other measurements of use that are used for the services for each customer are recorded. When the number of transactions to any one server reaches a number that begins to affect the performance of that server, other servers are accessed to increase the capacity and to share the workload. Likewise when other measurements of use such as network bandwidth, memory usage, storage usage, etc. approach a capacity so as to affect performance, additional network bandwidth, memory usage, storage etc. are added to share the workload.

The computer program product may be integrated into a client, server and network environment by providing for the computer program product to coexist with applications, operating systems and network operating systems software and then installing the computer program product on the clients and servers in the environment where the computer program product will function.

In one embodiment software is identified on the clients and servers including the network operating system where the computer program product will be deployed that are required by the computer program product or that work in conjunction with the computer program product. This includes the network operating system that is software that enhances a basic operating system by adding networking features.

In one embodiment, software applications and version numbers are identified and compared to the list of software applications and version numbers that have been tested to work with the computer program product. Those software applications that are missing or that do not match the correct version will be upgraded with the correct version numbers. Program instructions that pass parameters from the computer program product to the software applications will be checked to ensure the parameter lists match the parameter lists required by the computer program product. Conversely parameters passed by the software applications to the computer program product will be checked to ensure the parameters match the parameters required by the computer program product. The client and server operating systems including the network operating systems will be identified and compared to the list of operating systems, version numbers and network software that have been tested to work with the computer program product. Those operating systems, version numbers and network software that do not match the list of tested operating systems and version numbers will be upgraded on the clients and servers to the required level.

In response to determining that the software where the computer program product is to be deployed, is at the correct version level that has been tested to work with the computer program product, the integration is completed by installing the computer program product on the clients and servers.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and computer program products according to embodiments of the invention. It will be understood that each block of the schematic flowchart diagrams and/or schematic block diagrams, and combinations of blocks in the schematic flowchart diagrams and/or schematic block diagrams, can be implemented by program code. The program code may be provided to a processor of a general purpose computer, special purpose computer, sequencer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The program code may also be stored in a computer readable medium that can direct a computer, other programmable data processing apparatus, or other devices to function in a particular manner, such that the instructions stored in the computer readable medium produce an article of manufacture including instructions which implement the function/act specified in the schematic flowchart diagrams and/or schematic block diagrams block or blocks.

The program code may also be loaded onto a computer, other programmable data processing apparatus, or other devices to cause a series of operational steps to be performed on the computer, other programmable apparatus or other devices to produce a computer implemented process such that the program code which executed on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and computer program products according to various embodiments of the present invention. In this regard, each block in the schematic flowchart diagrams and/or schematic block diagrams may represent a module, segment, or portion of code, which comprises one or more executable instructions of the program code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and program code.

The description of elements in each figure may refer to elements of proceeding figures. Like numbers refer to like elements in all figures, including alternate embodiments of like elements.

Some terms from the parent application have been changed slightly to conform to the use of the terms in an implementation of the invention. A social media data source is referred to herein as a social source, a search engine data source is referred to herein as search source, a media data source is referred to herein as an image source and/or a video source, a review data source is referred to herein as a review source, a search phrase is referred to herein as a search target, and a search result is referred to herein as a result.

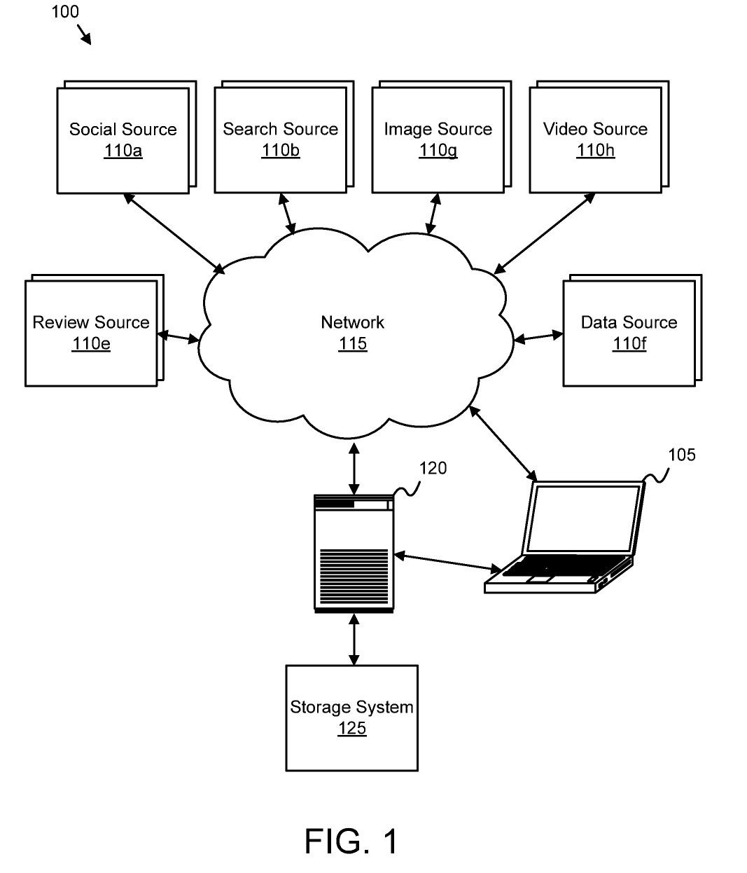

FIG. 1 is a schematic block diagram illustrating one embodiment of an internet presence scoring system 100. The system 100 includes a plurality of sources 110, a network 115, a server 120, a search computer 105, and a storage system 125.

The network 115 may comprise the Internet, a local area network, a wide area network, an ad hoc network, a private network, and/or a mobile telephone network. For example, the network 115 may include both the Internet and a private local area network.

The sources 110 may include without limitation one or more social sources 110a, one or more search sources 110b, one or more image sources 110g, one or more video sources 110h, one or more review sources 110e, and one or more data sources 110f. Each source 110 may be accessible through the network 115 such as through the Internet, a private network, and the like.

The server 120 may gather results from the plurality of the data sources 110 for a search target. In one embodiment, the server 120 performs searches on the one or more specified sources 110 for the search target. The server 120 may perform the searches using preferences. The preferences may include preferences for a specified user, preferences for a specified age group, preferences for a specified income bracket, preferences for a specified gender, and preferences for a specified locality. The server 120 may store the data in the storage system 125. The data may be organized in one or more databases, database tables, data files, and the like as will be described hereafter.

In a certain embodiment, the server 120 performs the searches through the search computer 105. The search computer 105 may be located in a specified location and have an Internet Protocol (IP) address associated with that location. As a result, the data gathered from the data sources 110 is analogous to the data available to a device residing at the specified location.

Results on the sources 110 are often indicative of the reputation of an individual, the popularity of a brand, and the penetration in society of a phrase or concept. Understanding this Internet presence is often vital in managing advertising campaigns, political campaigns, public awareness campaigns, product promotions, and the like.

Unfortunately, the information that is required to understand the Internet presence for a person, brand, or phrase is widely distributed in numerous data sources 110. This information is too numerous for an individual to gather and comprehend. In addition, understanding the sentiment of the information in each data source 110 may be too complex and diverse to be consistently evaluated by an individual or group.

The embodiments disclosed herein automatically calculate one or more metrics and an Internet score as a function of the sentiment value for each of a plurality of results from one or more sources 110. The Internet score objectively and rapidly determines both the quantity and quality of the Internet presence for a brand, an individual, or a phrase. With this information, campaigns can be formulated and adjusted for target audiences to better effect.

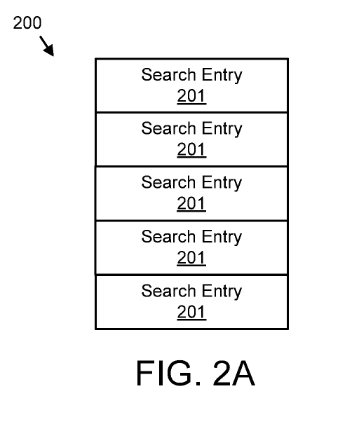

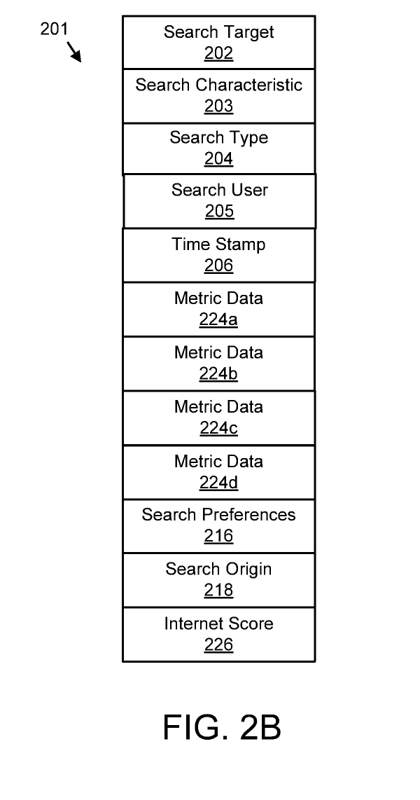

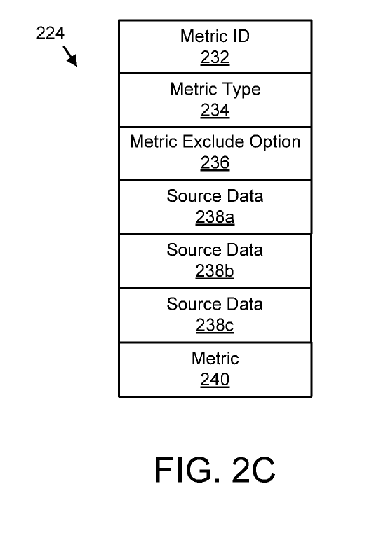

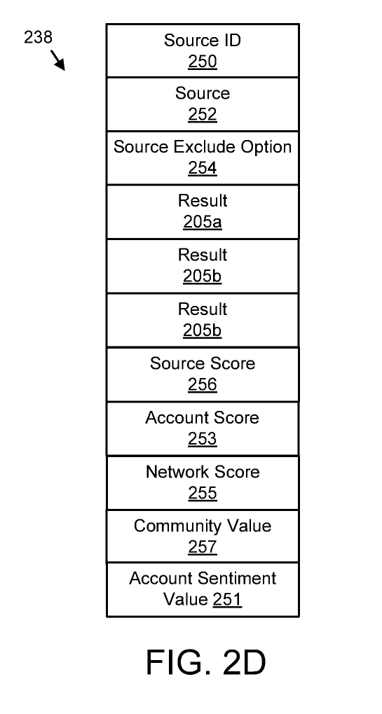

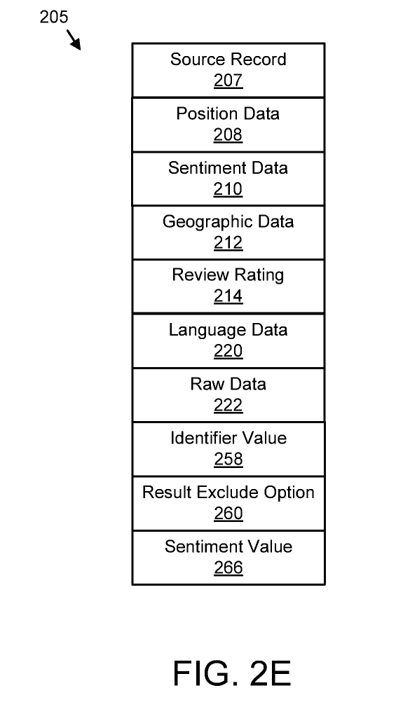

FIG. 2A is a schematic block diagram illustrating one embodiment of a search database 200. The search database 200 stores the results from each search of the data sources 110 as a search entry 201. The search database 200 may be stored on the storage system 125. For example, one or more clients may commission searches for search targets. The information from each search may be stored in the search database 200 as a search entry 201.

FIG. 2B is a schematic block diagram illustrating one embodiment of a search entry 201. The search entry 201 is the search entry 201 in the search database 200 of FIG. 2A. The search entry 201 may be stored in a data structure, a table, a database, or the like. Each search entry 201 may include the search target 202, a search characteristic 203, a search type 204, a search user 205, a timestamp 206, metric data 224, search preferences 216, a search origin 218, and the Internet score 226.

The search target 202 may be a brand name, an individual's name, and/or specified phrase. In one embodiment, the search target 202 may include one or more variations such as singular versions, plural versions, misspelled versions, and alternate versions of the search target 202.

The search characteristic 203 may filter results that are used to calculate the Internet score 226. The search characteristic 203 may include correlative search characteristics that are associated with the search target 202. For example, the search characteristics 203 may include a correlative search characteristic 203 of a city of residence for a person search target 202. In one embodiment, results that indicate a city other than the city of residence are excluded. Alternatively, results that do not indicate the city of residence may be excluded.

In addition, the search characteristics 203 may include non-correlative search characteristics that are not associated with the search target 202. For example, the search characteristics 203 may include a non-correlative search characteristic of a specified employer for a person search target 202. In one embodiment, results that indicate an employer other than the specified employer are excluded. Alternatively, results that do not indicate the specified employer may be excluded.

The search type 204 may be selected from the group consisting of a brand search type, a person search type, and a phrase search type. The brand search type, person search type, and phrase search type will be described in more detail hereafter. The search user 205 may indicate a user and/or a computer that initiates a search. In one embodiment, the search user 205 identifies an account. The search user 205 may be used to distinguish between Internet presence searches for the same search target 202 by different accounts, users, and/or from different computers.

The timestamp 206 may record the time of the search. In one embodiment, the timestamp 206 records the time at the initiation of the search. Alternatively, the timestamp 206 records the time at the completion of the search. In one embodiment, the timestamp 206 records a time interval of the search.

The search entry 201 includes metric data 224. Each metric data element 224 may point to a database and/or database entry for a metric as will be described hereafter for FIG. 2C.

The search preferences 216 may record the preferences used in the search. The preferences may include past searches, past results, past selected results, ratings of past results, geographic preferences, topical preferences, and the like. In one embodiment, the search preferences 216 specify limitations on the languages that are searched, negative limitations such as words and phrases that exclude a result 205 from consideration.

The search origin 218 may include the IP address from which the search is performed. In one embodiment, the search origin 218 specifies the search computer 105. The Internet score 226 stores a score calculated from the metrics and the metric data 224 as will be described hereafter.

FIG. 2C is a schematic block diagram illustrating one embodiment of the metric data 224. The metric data 224 may be stored in a data structure, a table, a database, or the like. The metric data 224 includes a metric identifier 232, a metric type 234, a metric exclude option 236, source data 238, and a metric 240.

The metric identifier 232 may uniquely identify the metric data 224. The metric identifier 232 may be an index. The metric type 234 may specify a search metric for search sources 110b, a social metric for social sources 110a, an image metric for image sources 110g, a video metric for video sources 110h, a review metric for review sources 110e, and a data metric for other data sources 110f.

The metric exclude option 236 may be set to exclude the metric data 224 and/or the metric 240 from calculating the Internet score 226. The metric exclude option 236 may be recorded in response to a selection by a user as will be described hereafter.

The source data 238 includes data from one or more sources 110 used to calculate the metric 240. The source data 238 will be described in more detail hereafter in FIG. 2D. The metric 240 may be calculated from the source data 238. In addition, the metric 240 may be used to calculate the Internet score 226.

FIG. 2D is a schematic block diagram illustrating one embodiment of the source data 238. The source data 238 may be stored in a data structure, a table, a database, or the like. In the depicted embodiment, the source data 238 includes a source identifier 250, a source 252, a source exclude option 254, one or more results 205, a source score 256, an account score 253, a network score 255, a community value 257, and an account sentiment value 251.

The source identifier 250 may uniquely identify the source data 238. The source identifier 250 may be an index. The source 252 identifies an origin of the source data 238. The source 252 may specify one of GOOGLE®, YAHOO®, BING®, FACEBOOK®, LINKEDIN®, TWITTER®, PICASA®, FLICKR®, GOOGLE® Images, MSN® Videos, YOUTUBE®, YELP®, and the like.

The source exclude option 254 may be set to exclude the source data 238 and/or the source score 256 from calculating the metric 240 for the metric data 224 and/or calculating the Internet score 226. The source exclude option 254 may be recorded in response to a user selection as will be described hereafter.

The results 205 may be returned by searching the source 252 for the search target 202. The search characteristics 203 may be used to modify the search of the source 252. The results 205 are described in more detail hereafter. The results 205 are used to calculate the source score 256, the account score 253, the network score 255, the community value 257, and/or the account sentiment value 251.

The account score 253 may calculated from results 205 within an account associated with the search target 202. The network score 255 may be calculated from results outside of the account of the search target 202, but within a network of the account of the search target 202. In one embodiment, the source score 256 is calculated as a function of the account score 253 and the network score 255 as will be described hereafter.

The community value 257 may be calculated from results 205 for accounts associated with a social media account of a search target 202. The account sentiment value 251 may be calculated from sentiment values for results 205 as will be described hereafter.

FIG. 2E is a schematic block diagram illustrating one embodiment of a result 205. The result 205 may be a result 205 of FIG. 2D. The result 205 may be stored in a data structure, a table, a database, or the like. In the depicted embodiment, the result 205 includes a source record 207, position data 208, sentiment data 210, geographic data 212, a review rating 214, language data 220, raw data 222, an identifier value 258, a result exclude option 260, and a sentiment value 266.

The data source record 207 specifies the source 110 from which the result 205 was received. In one embodiment, the data source record 207 includes a Universal Resource Locator (URL). Alternatively, the data source record 207 may include a name. For example, the data source record 207 may record the results 205 from a GOOGLE® search with the URL “google.com” or from a BING® search with the URL “bing.com.”

The position data 208 may specify a position of the result 205 for the search. If a search returns multiple results 205 arranged in a positional order, the position data 208 records the position of the result 205 within the positional order. For example, the position data 208 may include a page number and a page position.

Alternatively, the position data 208 may indicate the rank of the result 205 out of a specified number of results 205. In one embodiment, the specified number is 100 results 205. In one embodiment, the position data 208 also includes a position value. The position value may be determined from the page number and/or the page position as will be described hereafter.

The sentiment data 210 may record words, phrases, and images that indicate sentiment. In one embodiment, the sentiment data 210 includes a sentiment score for each word, phrase, and/or image as will be described hereafter. The sentiment scores may be used to calculate the sentiment value 266 as will be described hereafter.

The geographic data 212 may specify a geographic location associated with the result 205. For example, if the result 205 is from a review on a San Diego-based website, the geographic data 212 may record that the geographic location of the result 205 is San Diego, Calif.

The review rating 214 may include a numerical rating from a review. For example, if the review includes a rating with a scale of 1 to 5 stars, the review rating 214 may record the number of stars of the review. Alternatively, the review rating 214 may indicate a percentage of a perfect rating such as 100 percent.

The language data 220 may specify the language of the results 205. For example, a Spanish-language result 205 may be recorded as Spanish in the language data 220. The raw data 222 may record all the text and images of the result 205.

The identifier value 258 may indicate a value for a result identifier for the result 205. In one embodiment, the identifier value 258 is one of positive, neutral, and negative. Alternatively, identifier value 258 may be a numerical value.

The result exclude option 260 may be set to exclude the result 205 and/or the position data 208 and the sentiment data 210 from calculating the source score 256 for the source 252. The result exclude option 260 may be recorded in response to a user selection as will be described hereafter. The sentiment value 266 may indicate a positive sentiment, a neutral sentiment, a negative sentiment, and/or a numerical sentiment value. The calculation of the sentiment value 266 is described hereafter.

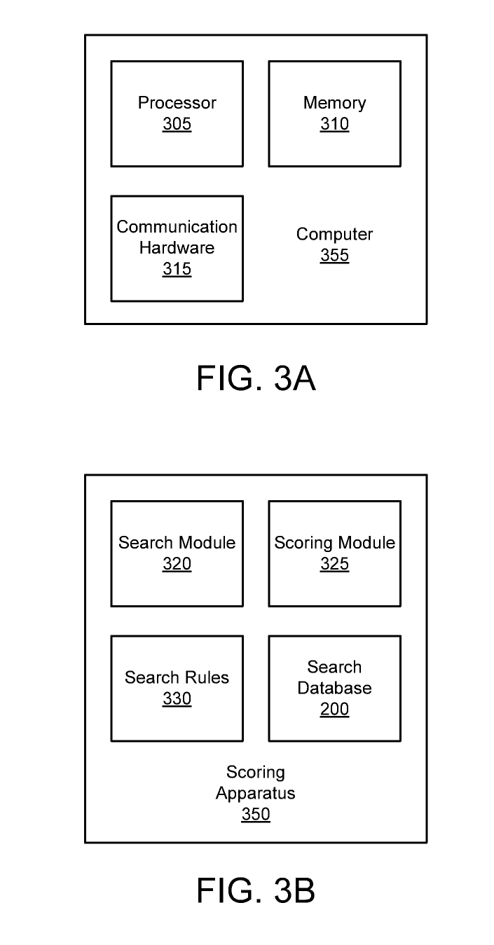

FIG. 3A is a schematic block diagram illustrating one embodiment of a computer 355. The computer 355 includes a processor 305, a memory 310, and communication hardware 315. The memory 310 may be a non-transitory computer readable storage medium such as a semiconductor storage device, a hard disk drive, a holographic storage device, a micromechanical storage device, or the like. The memory 310 may store program code. The processor 305 may execute the program code. The communication hardware 315 may communicate with other devices. The computer 355 may be embodied in the server 120. Alternatively, the computer 355 may be embodied in the search computer 105.

FIG. 3B is a schematic block diagram illustrating one embodiment of the scoring apparatus 350. The apparatus 350 may be embodied in the computer 355. The apparatus 350 may include a search module 320, scoring module 325, search rules 330, and the search database 200.

The search module 320, the scoring module 325, the search rules 330, and the search database 200 may be embodied in a computer readable storage medium such as the memory 310 storing program code. The program code may be executed by the processor 305 to perform the functions of the search module 320, the scoring module 325, the search rules 330, and the search database 200.

The search module 320 may initiate a search using the search target 202, the search characteristics 203, the search rules 330, the search preferences 216 and the search origin 218. The search module 320 may further retrieve a plurality of results 205 for the search target 202 from one or more specified data sources 110. The scoring module 325 may calculate one or more metrics 240 as a function of sentiment values for results 240 for the search target 202. The scoring module 325 may further calculate the Internet score 226 from the metrics 240 and display the Internet score 226 as will be described hereafter.

The search rules 330 may specify how each search is conducted. The search rules 330 may include but are not limited to URLs for sources 110, Application Program Interfaces (APL) for accessing sources 110, account credentials for accessing sources 110, and the like.

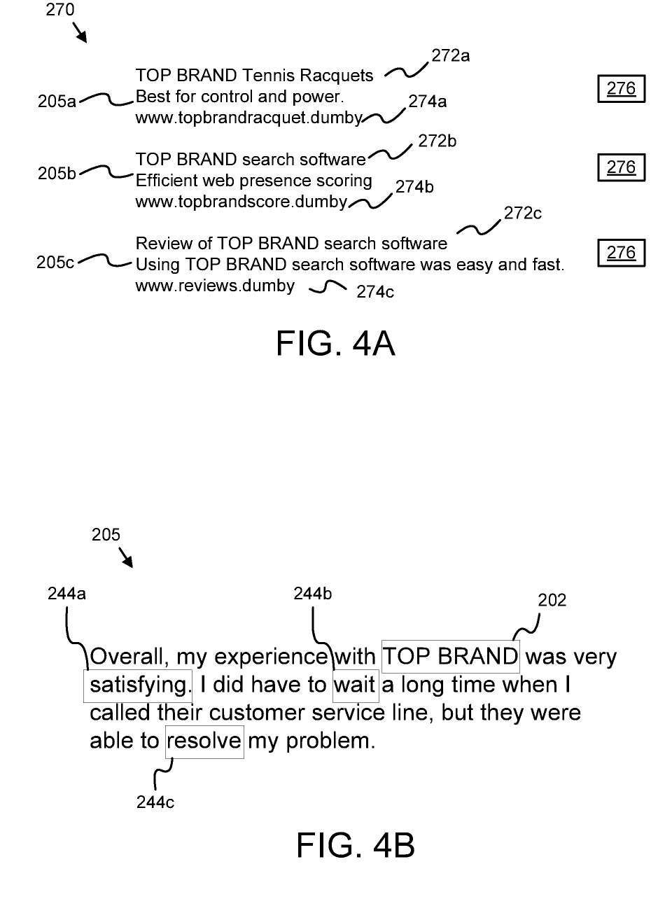

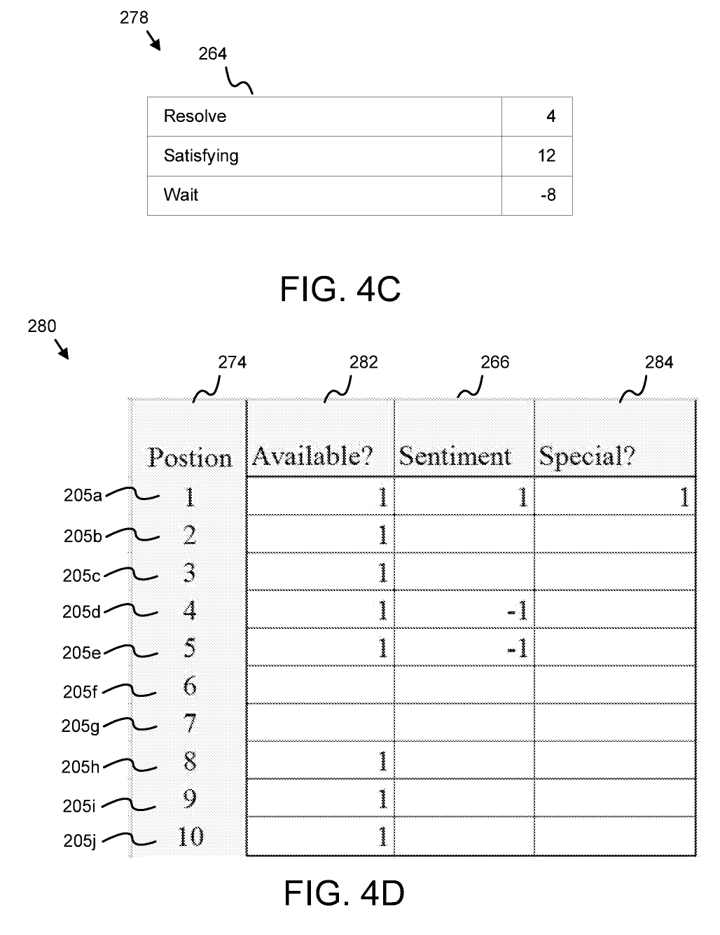

FIG. 4A is an illustration of one embodiment of displayed results 270. The displayed results 270 are exemplary of results 205 that may be returned by a search source 110b for the phrase “TOP BRAND.” Each result 205 includes a position 272. The position 272 may be recorded as position data 208. For example, a first position 272a may be recorded as page 1, position 1.

Each result 205 may also include a link 274. The link 274 may be recorded as the data source record 207. The results 205 may be received as HyperText Markup Language (HTML) formatted data. Alternatively, results 205 may be received in an eXtensible Markup Language (XML) format, as a delimited flat file, or in a format specified by an API.

A result identifier 276 may also be displayed for each result 205. The result identifier 276 may communicate the identifier value 258. For example, the result identifier 276 may display a green color for a positive identifier value 258, a gray color for a neutral identifier value 258, and a red color for a negative identifier value 258. In addition, the result identifier may indicate one of a friend, a follower, a hashtag, and an association for the result 205. The association may be a URL.

FIG. 4B is an illustration of one embodiment of sentiment identification. The sentiment information may be parsed from a result 205. In one embodiment, the sentiment information is parsed from the listing of a plurality of results 205 such as may be returned by a search source 110b. Alternatively, the sentiment information may be parsed from a source of the result 205, such as a Web page, XML file, formatted data, or other data source 110 communicated with through a link 274.

In one embodiment, the search target 202 is identified. The sentiment of the result 205 may be determined from words and images in proximity to the search target 202. In one embodiment, words within a specified word range of the search target 202 are analyzed for sentiment. The word range may be between 10 to 150 words.

In addition, images may be analyzed for sentiment. For example, an exclamation point, a checkmark, a thumbs-up image, 5 stars, and the like may be indicative of positive sentiment. Similarly, a thumbs down image, a single star, and the like may be indicative of negative sentiment.

Sentiment words 244 and images are identified within the word range. In one embodiment, all words and images within the word range are compared to a database of sentiment words. Words and images from within the word range that match entries in the sentiment word database may be recorded as sentiment data 210.

In one embodiment, a sentiment score from the sentiment word database may also be recorded as sentiment data 110. The sentiment value 266 may be calculated from one or more sentiment scores. In a certain embodiment, a sentiment value 266 of 1 is recorded for positive sentiment and a sentiment value 266 of −1 is recorded for negative sentiment. A sentiment value 266 of 0 may be recorded for neutral sentiment.

FIG. 4C is an illustration of one embodiment of sentiment scoring 278. Sentiment words 244 from FIG. 4B are shown listed as table entries 264. Each table entry 264 is associated with a sentiment score. The sentiment score may be indicative of the degree of positive or negative sentiment. The sentiment scores may be summed to calculate a sentiment value 266 for the result 205.

FIG. 4D is an illustration of one embodiment of position and sentiment scoring 280. In the depicted embodiment, results 205 for each position 274 from a search of a search source 110b are recorded. A position indication 282 is recorded if the search target 202 is found in each position 274. In addition, a sentiment value 266 is calculated for each search entry 205.

In one embodiment, the result 205 is marked as special in response to satisfying special criteria. Results from websites with .gov and/or .edu top-level domain names may satisfy the special criteria. Similarly, results from websites that exceed a traffic threshold may satisfy the special criteria. For example, the top 0.01 percent of websites in terms of traffic may satisfy the special criteria. In one embodiment, results from websites on a list satisfy the special criteria. The list may include specified news websites, encyclopedia websites, the websites of academic journals, and the like.

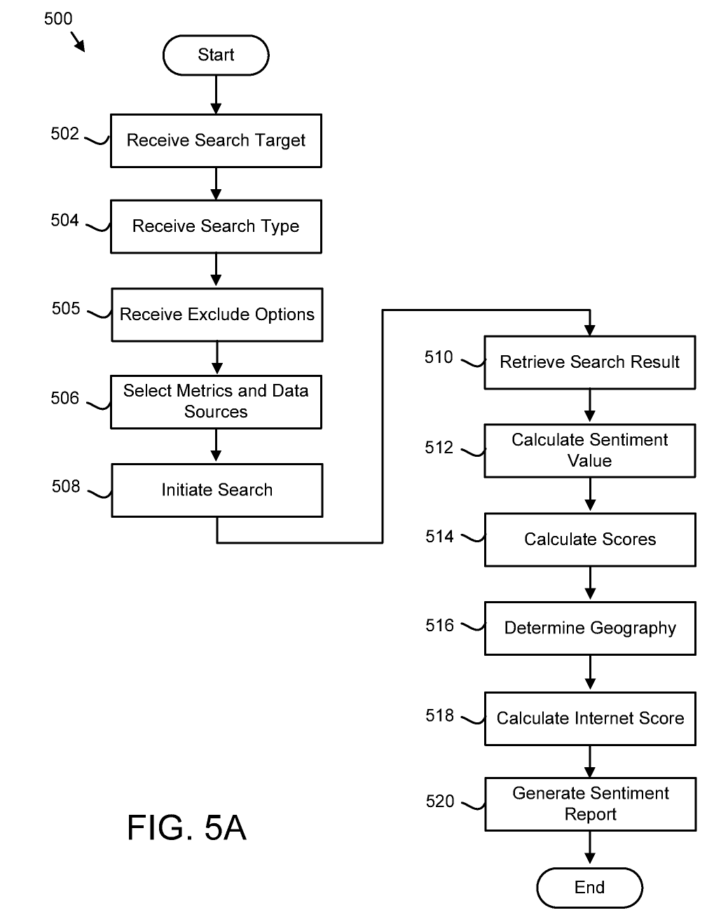

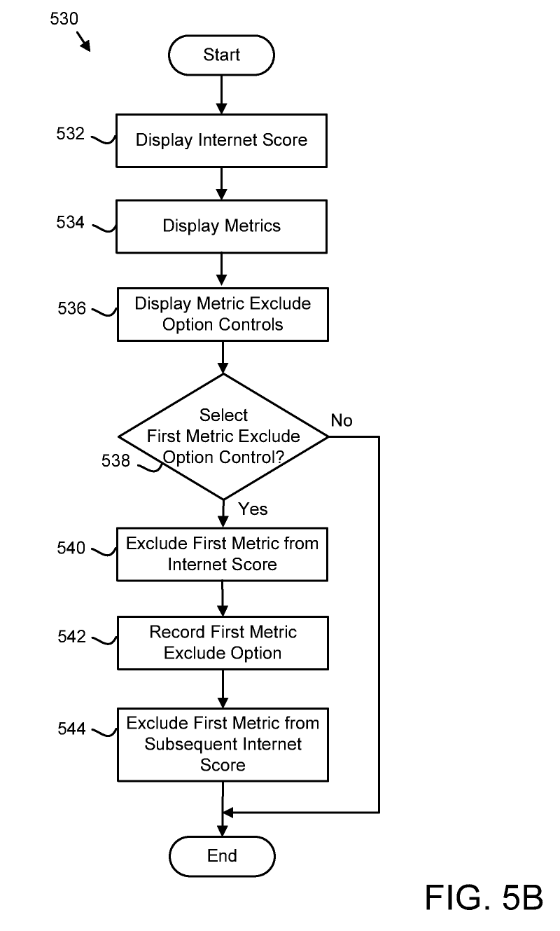

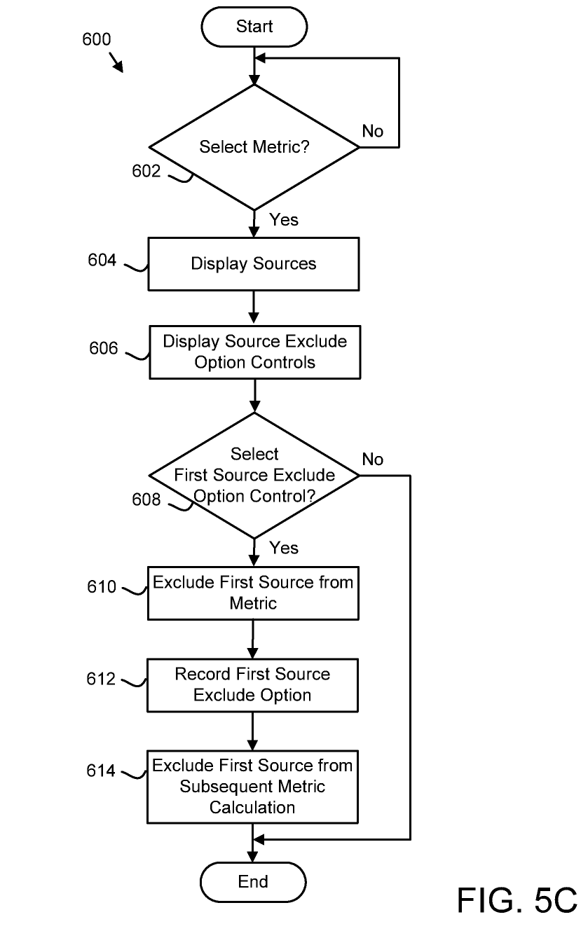

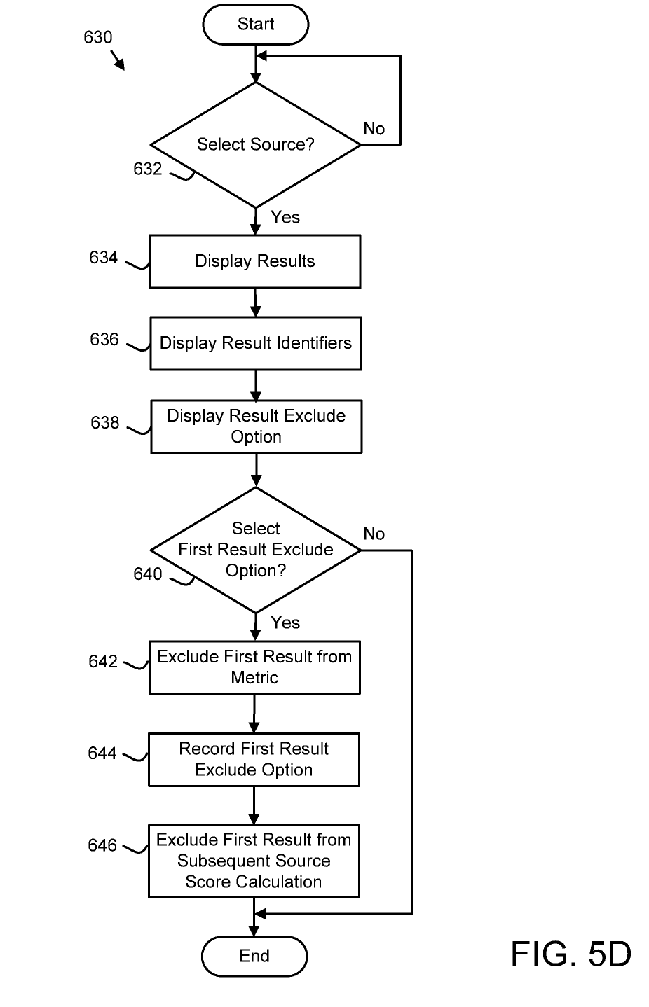

FIG. 5A is a schematic flow chart diagram illustrating one embodiment of an internet presence scoring method 500. The method 500 may perform the functions of the system 100 and the apparatus 350. In one embodiment, the method 500 is performed by the processor 305. Alternatively, the method 500 is performed by a computer readable storage medium such as the memory 310 storing program code. The processor 305 may execute the program code to perform the method 500.

The method 500 starts, and in one embodiment the search module 320 receives 502 the search target 202. The search target 202 may be received 502 when a search 201 is created. The search target 202 may be a word, a phrase, an image description, an image, a simplified image, or the like. In addition, the search target 202 may include search characteristics 203 and search preferences 216.

In one embodiment, the search target 202 is parsed from an optically scanned code. The optically scanned code may be a Quick Response (QR) code. For example, the search target 202 may be parsed from a QR code scanned from a product label using a mobile telephone and/or tablet computer.

The search module 320 may also receive 504 a search type 204. The search type 204 may be received 504 when the search 201 is initialized. In one embodiment, the search type 204 is specified with check boxes, buttons, radio buttons, or the like on a user interface. Alternatively, the search type 204 may be inferred from the search target 202. The search type 204 may be a brand search type, a person search type, and a phrase search type. The brand search type may be selected to determine an Internet presence for a brand. The brand may be a product, the trademark, a company, the service, and the like. The person search type may be selected to determine the Internet presence for an individual. Alternatively, the person search type may be selected to determine the Internet presence for a fictional individual. The phrase search type may be selected to determine the Internet presence of a phrase.

The search module 320 may receive 505 one or more exclude options. The exclude options may be one or more of the metric exclude option 236, the source exclude option 254, and the result exclude option 260. The exclude options may be selected by a user as will be described hereafter.

Alternatively, the exclude options may be retrieved from the search database 200. For example, the search module 320 may use the search target 202 and the search user 205 to retrieve one or more metric exclude options 236, the source exclude options 254, and the result exclude options 260 from the search database 200. The search module 320 may exclude metrics 240, source scores 256, and results 205 in response to the metric exclude options 236, the source exclude options 254, and the result exclude options 260 respectively.

In one embodiment, the search module 320 selects 506 one or more sources 110 in response to the search type 204. For example, if the search type 204 is person search type, the search module 320 may select 506 one or more social sources 110a, one or more search sources 110b, one or more image sources 110g, one or more video sources 110h, and one or more review sources 110e. In one embodiment, the specified source 110 is selected 506 from a data source list associated with each search type 204. Table 1 illustrates one embodiment of data source lists for search types 204.

TABLE 1

| Search Type 204 | Metric Type 234 | Data Source 110 |
|---|---|---|
| Person | Search | GOOGLE ® |
| | | YAHOO ® |
| | | BING ® |
| | Social | FACEBOOK ® |
| | | LINKEDIN ® |
| | | TWITTER ® |
| | Image | PICASA ® |
| | | FLICKR ® |
| | | GOOLGE ® Images |
| | Video | MSN ® Videos |
| | | YOUTUBE ® |
| | Review | YELP ® |
| Brand | Search | GOOGLE ® |
| | | YAHOO ® |
| | | BING ® |
| | Social | FACEBOOK ® |
| | | LINKEDIN ® |
| | | TWITTER ® |
| | Image | PICASA ® |
| | | FLICKR ® |
| | | GOOLGE ® Images |
| | Video | MSN ® Videos |
| | | YOUTUBE ® |
| | Review | YELP ® |
| Phrase | Search | GOOGLE ® |
| | | YAHOO ® |
| | | BING ® |
| | Social | FACEBOOK ® |
| | | LINKEDIN ® |
| | | TWITTER ® |
| | Image | PICASA ® |
| | | FLICKR ® |
| | | GOOLGE ® Images |
| | Video | MSN ® Videos |
| | | YOUTUBE ® |
| | Review | YELP ® |

The search module 320 may initiate 508 the search. In one embodiment, the search module 320 initiates 508 the search by communicating the search target 202 to each of the specified sources 110. The search module 320 may also communicate one or more commands such as a command to start the search. In addition, the search module 320 may communicate the search characteristics 203 and the search preferences 216 to the source 110. For example, the search module 320 may communicate correlative search characteristics, geographic preferences, negative search terms, and the like to the source 110. In one embodiment, results 205 are excluded if correlative search characteristics not are included or if non-correlative search characteristics are included. The search module 320 may also initiate the search through an API, by communicating an XML file, or the like.

The search module 320 may retrieve 510 the results 205 from the sources 110. One of skill in the art will recognize that the embodiments may be practiced with a plurality of sources 110 and a plurality of results 205. For simplicity, the sources 110 and the results 205 may be referred to in the singular. The results 205 may be stored in the storage system 125.

The scoring module 325 may calculate 512 a sentiment value 266 for each result 205. In one embodiment, each sentiment word 244 in the result 205 is identified. In addition, a sentiment score may be determined for each sentiment word 244. In a certain embodiment, the result sentiment value SV may be calculated using Equation 1, where SW is the sentiment score for each sentiment word 244 in the result 205.

SV=ΣSW Equation 1

In one embodiment, the result sentiment value 266 is normalized to a positive number such as 1 if the result sentiment value 266 is positive and to a negative number such as −1 if the result sentiment value 266 is negative. A result sentiment value 266 of zero may indicate neutral sentiment.

In one embodiment, the scoring module 325 calculates 514 scores including metrics 240 and source scores 256. In one embodiment, the scoring module 325 calculates 514 source scores 256 for each source 110 of the metric type 234. In addition, the scoring module 325 may calculate 514 the metrics 240 from the source scores 256 corresponding to each metric 240 as will be described hereafter.

The source score 256 for a social source 110a for the person search type 204 may be calculated as a function of the account score 253 and the network score 255. The social source score SO 256 may be calculated using Equation 2, where j is a percentage constant, AS is the account score 253, and AS is the network score 255.

SO=j*AS+(1−j)*NS Equation 2

In one embodiment, j is 50 percent. Alternatively, j may be in the range of 25 to 75 percent. Each of the account score 253 and the network score 255 for a person search type 204 may be calculated as a function of a likes to friends ratio, a number of friends, a comments to friends ratio, a shares to friends ratio, and a posts value. As used herein, a friend is a social media account of a second user that is associated with a social media account of the search target 202. A like is an indication of approval communicated between accounts. A share is a posting of a message, video, audio file, image, or the like to a social media account and may also be referred to as post. The share may be to the social media account of the search target 202 and/or to the friend account. A comment maybe a posting of a message, video, audio file, image, or the like to a share.

The likes to friends ratio LFR may be calculated using Equation 3, where k is a nonzero constant, LK is a number of likes received by a social media account such as FACEBOOK®, and FR as a number of friends associated with the social media account. The constant k may be one. In addition, k may have a different value for each equation.

LFR=k*LK/FR Equation 3

The number of friends may be a total number of friends associated with the social media account. The comments to friends ratio may be calculated using Equation 4, where k is the nonzero constant, CM is a number of comments received by the social media account, and FR is a number of friends associated with the social media account.

CFR=k*CM/FR Equation 4

The posts value may be calculated as a function of one or more of the length of a post, a frequency of posts by the user of the social media account, a frequency of posts by friends of the social media account, and post subject matter. A post may be a share, a comment, or the like. The shares to friends ratio SFR may be calculated using Equation 5, where k is the nonzero constant, SH is a number of shares to the social media account, and FR is the number of friends associated with the social media account.

SFR=k*SH/FR Equation 5

In one embodiment, each of the account score 253 and the network score 255 ANS are calculated as weighted sums of the likes to friends ratio LFR, the number of friends NF, the comments to friends ratio CFR, the shares to friends ratio SFR, and the posts value as shown in Equation 6, where k1, k2, k3, k4, and k5 are nonzero constants. In one embodiment, k1 is 5 percent, k2 is 40 percent, k3 is 15 percent, k4 is 20 percent, and k5 is 20 percent.

ANS=k1*LFR+k2*NF+k3*CFR+k4*SFR=k5*SFR Equation 6

Alternatively, each of the account score 253 and the network score 255 for a brand search type 204 may be calculated as a function of a followers value, a shares value, a likes to shares ratio, and a comments to shares ratio. As used herein, a follower is a social media account that receives posts from a first account. The followers value may be a function of the number of associated accounts connected to the first account. Associated accounts may be friends, followers, and the like associated with and/or linked to the account. In one embodiment, the followers value FV is calculated using Equation 7, where AV_{N} is as account score 253 calculated for each social media account associated with the social media account of the search target 202. In one embodiment, the percentage constant j is 100% for the brand search type 204.

FV=ΣAV_{N} Equation 7

The shares value SV may be calculated as a function of one or more of a length of a share, a frequency of shares from the social media account, a frequency of shares by friends of the social media account, and share subject matter. The likes to shares ratio LSR may be calculated using Equation 8, where k is the nonzero constant.

LSR=k*LK/SH Equation 8

The comments to shares ratio CSR may be calculated using Equation 9, where k is a nonzero constant.

CSR=k*SH/CM Equation 9

In one embodiment, each of the account score 253 and the network score 255 ANS are calculated as weighted sums of the followers value FV, the shares value SV, the likes to shares ratio LSR, and the comments to shares ratio CSR, as shown in Equation 10, where k1, k2, k3, and k4 are nonzero constants. In one embodiment, k1 is 50 percent, k2 is 25 percent, k3 is 5 percent, and k4 is 20 percent.

ANS=k1*FV+k2*SV+k3*LSR+k4*CSR Equation 10

Alternatively, each of the account score 253 and the network score 255 for a brand search type 204 may be calculated as a function of a connection value, a views value, a recent connection value, and a shown up value. The connection value may be a function of the number of connections to the social media account of the search target 202. For example, the connection value CNV may be calculated using Equation 11, where k is a nonzero constant and ANSᵢ is the account score 253 and/or network score 255 for each account associated with the account of the search target 202.

CNV=k*ΣANSᵢ Equation 11

The views value VWV may be a function of the number of views for shares and/or posts to the social media account of the search target 202. In one embodiment, the views value VWV is calculated using Equation 12, where k is a nonzero constant and VW is a view of a share and/or post.

VWV=k*ΣVW Equation 12

The recent connection value may be a function of new connections of other accounts to the social media account of the search target 202 within a connection time interval. The connection time interval may be in the range of 1 to 6 months. The recent connection value RCV may be calculated using Equation 13, where k is a nonzero constant and ANSᵢ is the account score 253 and/or network score 255 for each account newly associated with the account of the search target 202 within the connection time interval.

RCV=k*ΣANSᵢ Equation 13

The shown up value may be a function of a number of times that a result 205 from the social media account of the search target 202 is returned in any search. The search may be within the social source 110a. Alternatively, the search may be throughout the Internet. In one embodiment, the shown up value SUV is calculated using Equation 14, wherein k is a nonzero constant and AR is the number of searches returning information from the social media account of the search target 202.

SUV=k*AR Equation 14

In one embodiment, each of the account score 253 and the network score 255 ANS are calculated as weighted sums of the connection value, the views value, the recent connection value, and the shown up value, as shown in Equation 15, where k1, k2, k3, and k4 are nonzero constants. In one embodiment, k1 is 50 percent, k2 is 25 percent, k3 is 5 percent, and k4 is 20 percent.

ANS=k1*CNV+k2*VWV+k3*RCV+k4*SUV Equation 15

In one embodiment, source score 256 for a social source 110a is calculated as a function of an account score 253, a community value 257, and an account sentiment value 251. The account score 253 may be calculated as a function of a retweet value, a reply value, the followers value, a follower to following ratio, and a verify value.

The retweet value may be calculated as a function of the number and quality of re-postings of a post from the social media account of the search target 202. For example, the social media account of the search target 202 may communicate a post such as a tweet, a share, a blog, and the like. The post may be a text message, a video, an audio file, an image, or the like. Accounts associated with the social media account of the search target 202 may repost the post. In one embodiment, the retweet value RTV may be calculated using Equation 16, where k is a nonzero constant and ANS, is the account score 253 and/or network score 255 for each account associated with the account of the search target 202 that re-posts posts from the social media account of the search target 202.

RTV=k*ΣANSᵢ Equation 16

The reply value may be calculated as a function of replies from other accounts to a post to the social media account of the search target 202. In one embodiment, the reply value RPV is calculated using Equation 17, where k is a nonzero constant and ANS, is the account score 253 and/or network score 255 for each account associated with the account of the search target 202 that replies to posts from the social media account of the search target 202.

RPV=k*ΣANSᵢ Equation 17

The follower to following ratio may be calculated as a function of followers of a first account such as the social media account of the search target 202 to accounts followed by the first account. In one embodiment, the follower to following ratio FFR is calculated using Equation 18, where k is a nonzero constant, NFW is a number of followers of a first account, and NFL is a number of accounts followed by the first account. The first account may be the social media account of the search target 202 or an account associated with the social media account of the search target 202.

FFR=k*NFW/NFL Equation 18

The verify value may be a function of reposts and/or replies from verified accounts. A verified account is an account for which the identity of the account owner is verified. In one embodiment, the value of mentions, responses, and followers is increased for verified accounts, such as by multiplying the sentiment value 266 by a non-zero constant. In an alternative embodiment, the account valuation for an account is multiplied by non-zero constant if the account is a verified account. In a certain embodiment, the verify value VFV is calculated using Equation 19, where k is a nonzero constant and VANS, is the account score 253 and/or network score 255 for each verified account associated with the account of the search target 202 that reposts posts and/or replies to posts from the social media account of the search target 202.

VFV=k*ΣVANSᵢ Equation 19

The account score AS 253 may be calculated as a function of weighted sums of the retweet value RTV, the reply value RPV, the followers value FV, the follower to following ratio FFR, and the verify value VFV as shown in Equation 20, where k1, k2, k3, k4, and k5 are nonzero constants. In one embodiment, k1 is 20 percent, k2 is 20 percent, k3 is 20 percent, k4 is 20 percent, and k5 is 20 percent.

AS=k1*RTV+k2*RPV+k3*FV+k4*FFR+k5*VFV Equation 20

The community value may be calculated as a function of a hashtag value and/or a mention value for the first account. Mentions may be posts such as posts of images and/or text. For example, a posting of a text that included the search phrase 202 may be a mention. The community valuation may be increased if the mention is tagged with a hashtag that is used in a large number of mentions. Hashtags may be tags, categories, trending categories, or the like.

The hashtag value may be calculated as a function of a number of posts with hashtags employed by the first account and/or all accounts of the source 110. In addition, the mention value may be a number of all mentions similar to and/or identical to a mention of the first account. In one embodiment, the community valuation CV 257 is calculated using Equation 21, where NH is a number of hashtags and MV is the mention value and j is the percentage constant. In one embodiment, j is 50 percent.

CV=j*HV+(1−j)*MV Equation 21

The account sentiment value 251 may be calculated as a function of the sentiment values 266 of all posts to the first account. In one embodiment, the source score SS 256 is calculated as a weighted sum of the account score AS 253, the community value CV 257, and the account sentiment value ASV 251 as shown in Equation 22, where k1, k2, and k3 are nonzero constants.

SS=k1*AS+k2*CV+k3*ASV Equation 22

The source score 256 for a search source 110b, image source 110g, video source 110h, review source 110e, or other data source 110f may be calculated as a function the position value and the sentiment value for a specified number of the results from the source. In one embodiment, the source score SS 256 may be calculated as a function of a position value of each result 205 and the corresponding sentiment value 266 for the result 205. A search score component for a single result SRS may be calculated using Equation 23, where PV is the position value, SV is the sentiment value 266 for each sear result 205, and k is a non-zero constant.

SRS=k*PV*SV Equation 23

In an exemplary embodiment, the position value is determined using Table 2, where the position 274 of a result 205 is translated into a position value.

TABLE 2

| | | Alternate |
|---|---|---|
| Position | Position Value | Position Value |
| Page 1, Position 1 | 3 | 10 |
| Page 1, Position 2 | 2.97 | 5 |
| Page 1, Position 3 | 2.94 | 2 |
| Page 1, Position 4 | 2.91 | 1 |
| Page 1, Position 5 | 2.88 | 1 |
| Page 1, Position 6 | 2.85 | 1 |
| Page 1, Position 7 | 2.82 | 0.9 |
| Page 1, Position 8 | 2.79 | 0.8 |
| Page 1, Position 9 | 2.76 | 0.7 |
| Page 1, Position 10 | 2.73 | 0.6 |
| Page 2, Position 1 | 2.7 | 0.3 |
| Page 2, Position 2 | 2.673 | 0.3 |
| Page 2, Position 3 | 2.646 | 0.3 |
| Page 2, Position 4 | 2.619 | 0.3 |
| Page 2, Position 5 | 2.592 | 0.3 |
| Page 2, Position 6 | 2.565 | 0.3 |
| Page 2, Position 7 | 2.538 | 0.3 |
| Page 2, Position 8 | 2.511 | 0.3 |
| Page 2, Position 9 | 2.484 | 0.3 |
| Page 2, Position 10 | 2.457 | 0.3 |

Alternatively, the search score component for a single result SRS may be calculated as an inverse of the position value, such as by using Equation 24, where the position value PV is an ordinal number of the result 205, such as a 24th of 100 results 205.

SRS=k*SV/PV Equation 24

The source score 256 for a source 110 may be calculated as shown in Equation 25, where T_{S} is a constant assigned to the source 110 of the single result SRS. T_{S} may be a non-zero constant associated with the source 110.

SR=ΣT_{S}*SRS Equation 25

In one embodiment, only organic results 205 are used in determining the search score. In an alternate embodiment, both organic results 205 and paid results 205 are used in determining the search score. One of skill in the art will recognize that the embodiments may be practiced with other position values.

The scoring module 325 may further calculate 514 the metrics 240 from the source scores 256 for the source data 238 associated with a metric result 224. In one embodiment, each metric MR 240 is calculated as a weighted sum of the source scores 256 associated with the metric results 224 as shown in Equation 26, where kᵢ is a nonzero constant for a source score SS, 256 of a specified source 110.

MR=ΣkᵢSSᵢ Equation 26

The scoring module 325 may further determine 516 a geography for each of the results 205. The geography may be recorded as geographic data 212. In one embodiment, each source score 256 and/or metric 240 is calculated for a specified geography.

The scoring module 325 may further calculate 518 the Internet from the one or more metrics 240. The Internet score 226 may be calculated as a function of the sentiment values 266 for each of the plurality of results 205. In one embodiment, the Internet score IS 226 is calculated using Equation 27, where SM is a search metric, or when is a social metric, IM is an image metric, VM is a video metric, RM is a review metric, and k1, k2, k3, k4, and k5 are nonzero constants.

IS=k1*SM+k2*OM+k3*IM+k4*VM+k5*RM Equation 27

In one embodiment, the constants k1, k2, k3, k4, and k5 have the ranges specified in Table 3 for a person search type.

TABLE 3

| | Low Value | High Value |
|---|---|---|
| Constant | (%) | (%) |
| k1 | 20 | 30 |
| k2 | 45 | 55 |
| k3 | 7 | 12 |
| k4 | 3 | 6 |
| k5 | 4 | 13 |

In one embodiment, the constants k1, k2, k3, k4, and k5 have the ranges specified in Table 4 for a brand search type.

TABLE 4

| | Low Value | High Value |
|---|---|---|
| Constant | (%) | (%) |
| k1 | 30 | 40 |
| k2 | 15 | 25 |
| k3 | 25 | 35 |
| k4 | 0 | 0 |
| k5 | 8 | 13 |

In one embodiment, the constants k1, k2, k3, k4, and k5 have the ranges specified in Table 5 for the phrase search type.

TABLE 5

| | Low Value | High Value |
|---|---|---|
| Constant | (%) | (%) |
| k1 | 65 | 75 |
| k2 | 15 | 25 |
| k3 | 0 | 0 |
| k4 | 0 | 0 |
| k5 | 3 | 6 |

In one embodiment, the presentation of details of the Internet score calculation depends on an account type. For example, calculation details including metrics 240, source scores 256, and results 205 may be presented for a paid premium account while only the Internet score 226 is presented for a standard free account. The Internet score 226 for a premium account may identify results 205, sources 110, and the like that significantly contributed to the Internet score 226.

The scoring module 325 may generate 520 a sentiment report and the method 500 ends. The sentiment report may include the Internet score 226, the one or more metrics 240, and third-party data. The third-party data may include additional evaluations of the search target 202.

FIG. 5B is a schematic flow chart diagram illustrating one embodiment of a metric exclusion method 530. The method 530 may perform the functions of the system 100 and the apparatus 350. In one embodiment, the method 530 is performed by the processor 305. Alternatively, the method 530 is performed by a computer readable storage medium such as the memory 310 storing program code. The processor 305 may execute the program code to perform the method 530.

The method 530 starts, and in one embodiment, the scoring module 325 displays 532 the Internet score 226. The Internet score 226 may be displayed in the browser window in response to the Internet presence scoring method 500 of FIG. 5A. The scoring module 325 may further display 534 the metrics 240 calculated by the method 500.

In one embodiment, the scoring module 325 displays 536 metric exclude option controls for each metric 240. The scoring module 325 may further determine 538 if a user selects a first metric exclude option control. If the user does not select a first metric exclude option control, the method 530 ends.

If the user selects a first metric exclude option control, the scoring module 325 may exclude 540 a first metric 240 from calculating the Internet score 226. For example, the scoring module 325 may exclude 540 the first metric 240 while using Equation 27 to calculate the Internet score 226. The scoring module 325 may further record 542 the first metric exclude option 236. In one embodiment, the scoring module 325 sets the first metric exclude option 236.

In one embodiment, the scoring module 325 may exclude 544 the first metric 240 from subsequent Internet scores 226 and the method 530 ends. For example, if the scoring module 325 is recalculating 518 the Internet score 226, the scoring module 325 may identify the first metric 240 is for a same search target 202 and search user 205. As a result, the scoring module 325 may exclude 544 the first metric 240 from the calculation of the Internet score 226.

In one embodiment, a user may clear the first metric exclude option control and the first metric 240 will be used to calculate the Internet score 226. In addition, the first metric exclude option 236 may be cleared.

FIG. 5C is a schematic flow chart diagram illustrating one embodiment of a source exclusion method 600. The method 600 may perform the functions of the system 100 and the apparatus 350. In one embodiment, the method 600 is performed by the processor 305. Alternatively, the method 600 is performed by a computer readable storage medium such as the memory 310 storing program code. The processor 305 may execute the program code to perform the method 600.

The method 600 starts, and in one embodiment, the scoring module 325 determines 602 if the user has selected a first metric 240 displayed with the Internet score 226. If the user has not selected the first metric 240, the scoring module 325 continues to determine 602 if the user has selected the first metric 240.

If the user has selected the first metric 240, the scoring module 325 displays 604 the sources 110 for the first metric 240. For example, if the user selects the search metric 240, the scoring module 325 may display 604 text indicating that GOOGLE®, YAHOO®, and BING® sources 110 were searched to calculate the search metric 240.

The scoring module 325 may further display 606 source exclude option controls for each source 110. The scoring module 325 may determine 608 if the user selects a first source exclude option control. If the user does not select a first source exclude option control, the method 600 ends.

If the user selects a first source exclude option control corresponding to a first source 110 of the first metric 240, the scoring module 325 may exclude 610 the first source score 256 of the first source 110 from calculating the first metric 240 and/or the Internet score 226. The scoring module 325 may further record 612 the first source exclude option 254. In one embodiment, the scoring module 325 sets the first source exclude option 254.

In one embodiment, the scoring module 325 may exclude 614 the first source score 256 from subsequent calculations of the first metric 240 and the method 600 ends. For example, if the scoring module 325 is recalculating 518 the first metric 240 using Equation 26, the scoring module 325 may identify that the first source score 256 is for a same search target 202 and search user 205. As a result, the scoring module 325 may exclude 614 the first source score 256 from the subsequent calculation 518 of the first metric 240.

In one embodiment, a user may clear the first source exclude option control and the first source score 256 may be used to calculate the first metric 240. In addition, the first source score exclude option 254 may be cleared.

FIG. 5D is a schematic flow chart diagram illustrating one embodiment of a result exclusion method 630. The method 630 may perform the functions of the system 100 and the apparatus 350. In one embodiment, the method 630 is performed by the processor 305. Alternatively, the method 630 is performed by a computer readable storage medium such as the memory 310 storing program code. The processor 305 may execute the program code to perform the method 630.

The method 630 starts, and in one embodiment, the scoring module 325 determines 632 if the user has selected a first source 110 displayed in response to selecting a first metric 240. If the user has not selected the first source 110, the scoring module 325 continues to determine 632 if the user has selected the first source 110.

If the user has selected the first source 110, the scoring module 325 displays 634 the results 205 from the first source 110. For example, if the user selects the BING® source 110, the scoring module 325 may display 634 all the results 205 from the BING® source 110.

In one embodiment, the scoring module 325 displays 636 result identifiers 276 for each result 205. The scoring module 325 may further display 638 result exclude option controls for each result 205. The scoring module 325 may further determine 640 if a user selects a first result exclude option control for a first result 205. If the user does not select a first result exclude option control, the method 630 ends.

If the user selects the first result exclude option control, the scoring module 325 may exclude 642 the first result 205 from calculating the first source score 256 for the first source 110. The scoring module 325 may further record 644 the first result exclude option 260 for the first result 205. In one embodiment, the scoring module 325 sets the first result exclude option 260.

In one embodiment, the scoring module 325 may exclude 646 the first result 205 from subsequent calculations of the first source score 256 and the method 630 ends. For example, if the scoring module 325 is recalculating the first source score 256, the scoring module 325 may identify the first source score 256 is for a same search target 202 and search user 205. As a result, the scoring module 325 may exclude 646 the first result 205 from the calculation of the first source score 256.

In one embodiment, a user may clear the first result exclude option control and the first result 205 may be used to calculate the first source score 256. In addition, the first result exclude option 260 may be cleared.

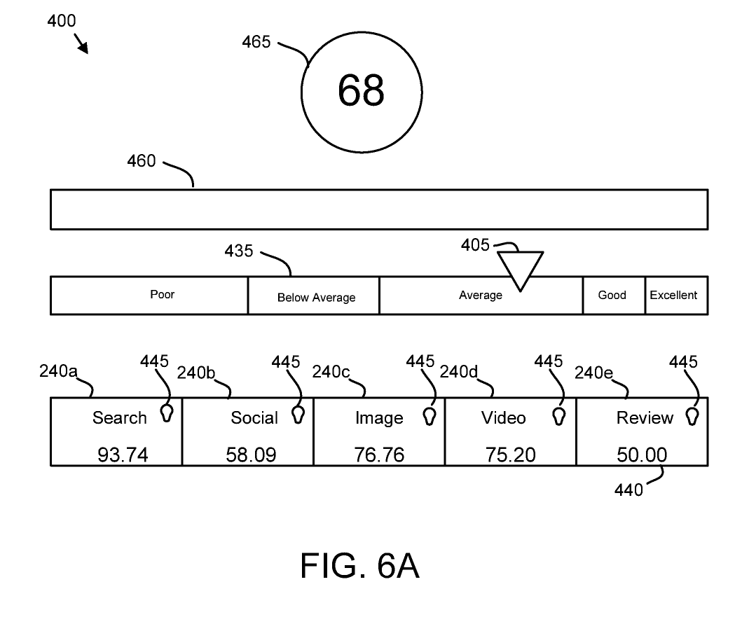

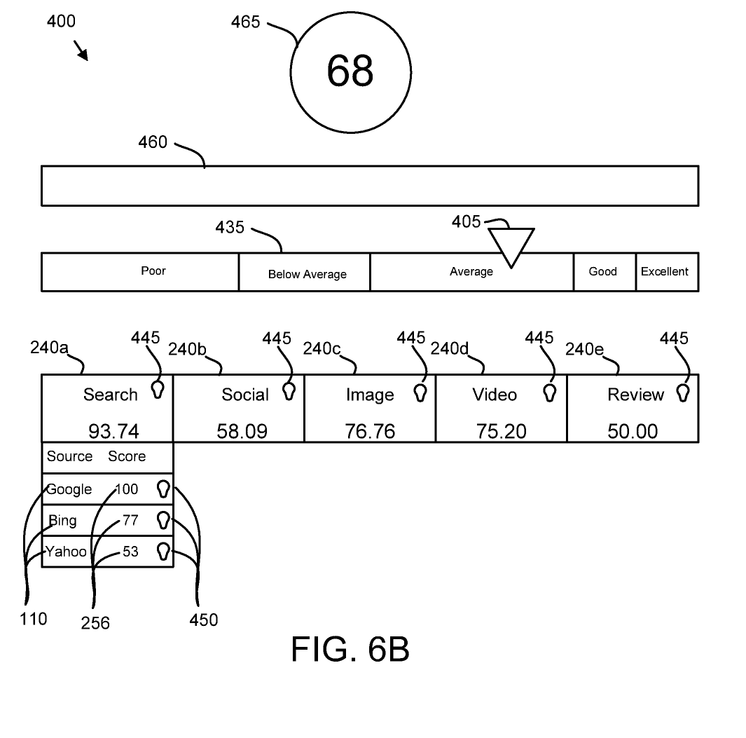

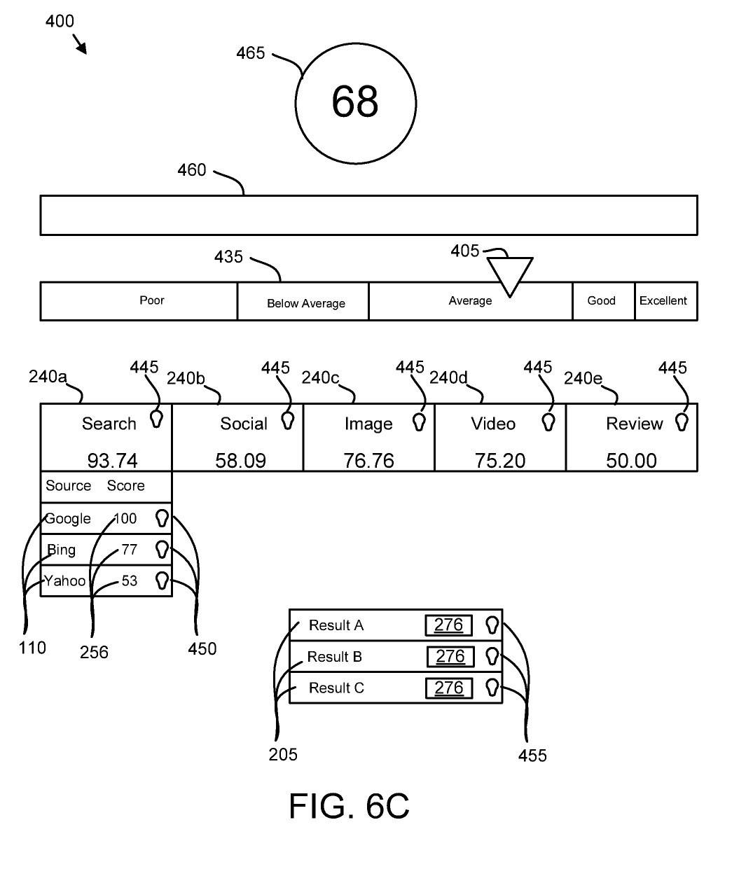

FIG. 6A is an illustration of one embodiment of a displayed Internet presence score 400. The Internet presence score 400 may be displayed within a browser. A user may enter the search target 202 in the search field 460. In the depicted embodiment, the Internet presence score 400 includes the Internet score 266 displayed as a number 465. The Internet presence score 400 may include a meter 435 displaying the Internet score 226 with an Internet score marker 405. In addition, the Internet presence score 400 may include a summary 440 of the metrics 240 including but not limited to the search metric 240a, the social metric 240b, the image metric 240c, the video metric 240d, and a review metric 240e.

Each metric 240 may include a metric exclude option control 445. Selecting the metric exclude option control 445 may exclude the corresponding metric 240 from the calculation of the Internet score 226.

FIG. 6B is an illustration of one alternate embodiment of a displayed Internet presence score 400. In the depicted embodiment, sources 110 and source scores 256 for a first metric 240, the search metric 240a, are displayed in response to the user selecting the search metric 240a. Each source 110 and corresponding source score 256 for the metric 240 is displayed. In addition, a source exclude option control 450 is displayed for each data source 110. Selecting the source exclude option control 450 may exclude the corresponding source 110 from the calculation of the first metric 240.

FIG. 6C is an illustration of one alternate embodiment of a displayed Internet presence score 400. In the depicted embodiment, results 205 for a first source 110 are displayed in response to the user selecting the first source 110. The result 205, a result identifier 276, and a result exclude option control 455 may be displayed. Selecting the result exclude option control 455 may exclude the corresponding result 205 from the calculation of the source score 256 for the first source 110.

The embodiments calculate metrics 240 as a function of sentiment values 266 for results 205 for a search target 202 of a search type 204. The embodiments further calculate an Internet score 226 from the metrics 240 and display the Internet score 226. The Internet score 226 may be used to evaluate an Internet presence, and to manage advertising campaigns, political campaigns, public awareness campaigns, product promotions, and the like. The embodiments automate the processing of the large amounts of data that reflect on an Internet presence. As a result, an effective measure of the Internet presence may be calculated.

The embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method for internet presence scoring comprising:
calculating, by use of a processor, one or more metrics as a function of sentiment values for results for a search target of a search type comprising one of a person search type and a brand search type;
calculating an Internet score from the one or more metrics; and
displaying the Internet score.

2. The method of claim 1, wherein the one or more metrics comprise a search metric calculated as a function of source scores from one or more search sources, a social metric calculated as a function of source scores from one or more social sources, an image metric calculated as a function of source scores from one or more image sources, a video metric calculated as a function of source scores from one or more video sources, and a review metric calculated as a function of source scores from one or more review sources.

3. The method of claim 2, wherein each source score is calculated as a function of a position value and the sentiment value for a specified number of the results from the source.

4. The method of claim 3, wherein the position value is an inverse of a result rank and the sentiment value is a positive specified value for a positive sentiment phrase and a negative specified value for a negative sentiment phrase.

5. The method of claim 4, wherein the sentiment value for a first result is calculated as a sum of sentiment values for each sentiment phrase in the first result.

6. The method of claim 2, wherein the source score for a first social source for the person search type is calculated as a function of an account score and a network score, and each of the account score and the network score is calculated as a function of a likes to friends ratio, a number of friends, a comments to friends ratio, a shares to friends ratio, and a posts value.

7. The method of claim 2, wherein the source score for a first social source for the brand search type is calculated as a function of a followers value, a shares value, a likes to shares ratio, and a comments to shares ratio.

8. The method of claim 2, wherein the source score for a first social source for the person search type is calculated as a function of an account score and a network score, and each of the account score and the network score is calculated as a function of a connection value, a views value, a recent connection value, and a shown up value.

9. The method of claim 2, wherein the source score for a first social source is calculated as a function of an account score, a community value, and an account sentiment value, the account score is calculated as a function of a retweet value, a reply value, a followers value, a follower to following ratio, and a verify value, and the community value is calculated as a function of a hashtag value and a mention value.

10. The method of claim 1, wherein results for the Internet score are filtered using one or more search characteristics, the search characteristics comprising correlative search characteristics that are associated with the search target and non-correlative search characteristics that are not associated with the search target.

11. The method of claim 1, the method further comprising:
displaying each metric;
displaying a metric exclude option for each metric; and
excluding a first metric from the Internet score calculation in response to a selection of the metric exclude option for the first metric.

12. The method of claim 11, the method further comprising:
displaying a plurality of sources for a plurality of results that are used to calculate a first metric in response to a selection of the first metric; and
displaying a source score for each source.

13. The method of claim 12, the method further comprising:
displaying a source exclude option for each source; and
excluding a first source from the calculation of the first metric in response to a selection of the source exclude option for the first source.

14. The method of claim 13, the method further comprising:
displaying a plurality of results that are used to calculate the source score for a first source in response to a selection of the first source; and
displaying a sentiment indicator for each result.

15. The method of claim 14, the method further comprising:
displaying a result exclude option for each result; and
excluding a first result from the calculation of the source score for the first source and the first metric in response to a selection of the result exclude option for the first result.

16. The method of claim 14, the method further comprising displaying a result identifier for each result.

17. The method of claim 16, wherein each result identifier indicate one of a friend, a follower, a hashtag, and an association.

18. The method of claim 1, the method further comprising generating a sentiment report comprising the Internet score, the one or more metrics, and third-party data.

19. The method of claim 1, wherein the Internet score is a displayed as a number.

20. The method of claim 1, wherein the Internet score is a displayed as a meter.
